(19) United States
(12) Patent Application Publication
(10) Pub. No.: US 2010/0000031 A1
(43) Pub. Date: Jan. 7, 2010

(54) MIGRATION-STABLE DYES IN POLYMERIC MATERIALS VIA COMPLEX FORMATION OF POLYISOBUTENE DERIVATIVES WITH DYES

(75) Inventors: Claudia Sierakowski, Seeheim-Jugenheim (DE); Ulrich Karl, Grunstadt (DE); Jaques Tesse, Compiegne (FR); Karin Fischl, Ludwigshafen (DE); Michael Faber, Schifferstadt (DE)

Correspondence Address: CONNOLLY BOVE LODGE & HUTZ LLP, 1875 EYE STREET, N.W., SUITE 1100, WASHINGTON, DC, 20006, US

(73) Assignee: Basf SE, Ludwigshafen (DE)

(21) Appl. No.: 12/095,689

(22) PCT Filed: Nov. 27, 2006
(86) PCT No.: PCT/EP06/68950

§ 371 Date: May 30, 2008

(30) Foreign Application Priority Data
Dec. 2, 2005 (DE) 10 2005 057 886.1
Jun. 1, 2006 (EP) 06114876.3

(51) Int. Cl. C09B 67/00; C08L 53/00; B32B 37/12

(52) U.S. Cl. 8/552; 524/505; 156/272.8

(57) ABSTRACT

Dye concentrate comprising at least one polyisobutene derivative composed of at least one hydrophobic block (X) and at least one hydrophilic block (Y) as component A and at least one dye as component B and also a dye concentrate which, as well as components A and B, comprises at least one polyolefin as component C1 and/or at least one solvent as component C2, production of the dye concentrates, coloration of polymeric materials by contacting the polymeric materials with the dye concentrates of the present invention, colored polymeric compositions composed of at least one dye concentrate of the present invention and at least one polymeric material, fibers, films, packaging, moldings composed of the colored polymeric composition of the present invention, the use of the dye concentrates of the present invention for coloration of polymeric materials, and also the use of polyisobutene derivatives composed of at least one hydrophobic block (X) and at least one hydrophilic block (Y) as an auxiliary for migration-resistant coloration of polymeric materials. The present invention further concerns the present invention's process for coloration of polymeric materials wherein the polymeric materials are additionally contacted with a block copolymer (component E), the present invention's colored polymeric composition which, as well as the at least one dye concentrate and the at least one polymeric material, comprises at least one block copolymer (component E) and the present invention's use of the present invention's dye concentrates for coloration of polymeric materials wherein the polymeric materials are present in a polymeric composition which, as well as the at least one polymeric material, comprises at least one block copolymer E, and also the present invention's use of polyisobutene derivatives composed of at least one hydrophobic block (X) and at least one hydrophilic block (Y) for migration-resistant coloration of polymeric materials by incorporation of a dye concentrate wherein additionally a block copolymer E is incorporated.

The present invention concerns a dye concentrate comprising at least one polyisobutene derivative composed of at least one hydrophobic block (X) and at least one hydrophilic block (Y) as component A and at least one dye as component B and also a dye concentrate which, as well as components A and B, comprises at least one polyolefin as component C1 and/or at least one solvent as component C2, production of the dye concentrates, coloration of polymeric materials by contacting the polymeric materials with the dye concentrates of the present invention, colored polymeric compositions composed of at least one dye concentrate of the present invention and at least one polymeric material, fibers, films, packaging, moldings composed of the colored polymeric composition of the present invention, the use of the dye concentrates of the present invention for coloration of polymeric materials, and also the use of polyisobutene derivatives composed of at least one hydrophobic block (X) and at least one hydrophilic block (Y) as an auxiliary for migration-resistant coloration of polymeric materials. The present invention further concerns the present invention's process for coloration of polymeric materials wherein the polymeric materials are additionally contacted with a block copolymer (component E), the present invention's colored polymeric composition which, as well as the at least one dye concentrate and the at least one polymeric material, comprises at least one block copolymer (component E) and the present invention's use of the present invention's dye concentrates for coloration of polymeric materials wherein the polymeric materials are present in a polymeric composition which, as well as the at least one polymeric material, comprises at least one block copolymer E, and also the present invention's use of polyisobutene derivatives composed of at least one hydrophobic block (X) and at least one hydrophilic block (Y) for migration-resistant coloration of polymeric materials by incorporation of a dye concentrate wherein additionally a block copolymer E is incorporated.

Polymeric materials such as polyolefins, in particular polypropylene, have numerous outstanding properties such as low specific density, high breaking strength, good resistance to chemicals, low wettability by polar media, low water imbibition, good recyclability and also low cost. They are outstandingly processable into various forms such as fibers, films and moldings.

Owing to their low wettability by polar substances and/or their low ability to imbibe polar substances, polyolefins and other apolar polymeric materials and also fibers, films and moldings produced therefrom are very difficult to color in such a way that the dyes used do not migrate out during the use of the polyolefins and of other apolar polymeric materials.

To achieve deep and migration-resistant shades on apolar polymeric materials such as polyolefins, it has hitherto been customary to employ mass coloration whereby a particulate colored pigment is added to the polymer while it is still in the extruder, in the first step of a yarn-manufacturing operation for example. Mass coloration does indeed provide colorations which are both dark and fast to the rigors of actual service, but pigment coloration does require distinctly more costly colorant than coloration with dyes. Moreover, bright and transparent hues are difficult to achieve with pigments. Moreover, the particulate nature of the pigments may for example cause the fine dies used for extruding yarns to become clogged up, or the breaking strength of the fiber decreases. Moreover, coloration of polyolefins and other apolar polymeric materials with pigments is costly.

It is possible in principle to dye polyolefins with dyes from an aqueous liquor. However, dyeing is disadvantageous when thick articles are to be colored, since dyes applied from an aqueous liquor penetrate into the articles from out to in and homogeneous coloration of comparatively thick articles is thus difficult.

There have been numerous prior art attempts to improve the dyeability, in particular the migration-resistant dyeability, of apolar polymeric materials, in particular polyolefins.

The dyeing of polyolefins from an aqueous liquor is disclosed for example in DE-A 2 240 534 and EP-A 0 039 207.

DE-A 2 240 534 concerns dyeable polyolefin-based polymeric compositions comprising as an additive for improving the dyeing of polymeric compositions a polyamine adduct comprising at least one hydrocarbon chain of at least 25 carbon atoms which is attached to a nitrogen atom. The additives are incorporated in the polymeric composition by mixing with the polyolefin. The polyolefins are dyed with premetalized or disperse dyes or preferably with acidic dyes in an aqueous dyebath.

EP-A 0 039 207 discloses modifying a polyolefin fiber by incorporating nitrogenous, basic copolymers in the spinning melt of a polyolefin material. The basic copolymers thereby become attached in the macromolecule. These modified polyolefins then have an affinity for anionic dyes. The modified polyolefin fiber is dyed from an aqueous liquor.

As mentioned above, when comparatively thick polyolefin articles are dyed from an aqueous liquor the dyeings or colorations achieved are generally not homogeneous. To achieve homogeneous, migration-resistant colorations of polyolefins, mass coloration of the polyolefins is therefore preferable. As well as pigments being used in mass coloration, there is prior art whereby modified dyes are used for mass coloration of polyolefins.

EP-A 0 215 322 concerns colored thermoplastic compositions comprising a thermoplastic and a colorant in the form of a polyalkyleneoxy-substituted chromophore group provided in the thermoplastic in a minor amount sufficient to provide coloration to the thermoplastic. According to EP-A 0 215 322, the chromophore group is attached to the polyalkyleneoxy radical by covalent bonding. The specific colorant is incorporated in the thermoplastic, for example, by addition into the melt of the thermoplastic. Polyolefins are mentioned as an example of thermoplastics. EP-A 0 445 926, EP-A 0 398 620 and EP-A 0 437 105 likewise concern colorants modified by covalent attachment of polyoxyalkylene groups to the chromophore group used. However, this technology is very costly, since each particular dye has to be appropriately modified before use.

It is an object of the present invention against the prior art cited above to provide dye concentrates that are suitable for mass coloration of polymeric materials such as polyolefins, in particular polypropylene, such that the dyes used cannot migrate out of the colored polyolefins. These dye concentrates shall be simple to obtain and usable with a broad gamut of dyes. Preferably strong, brilliant and transparent colorations are to be achievable with the aid of the dye concentrates and also any desired combination shades, and the dye concentrates shall have a high color strength in order that economical coloration of polymeric materials such as polyolefins may be made possible.

We have found that this object is achieved by a dye concentrate comprising
a) at least one polyisobutene derivative composed of at least one hydrophobic block (X) and at least one hydrophilic block (Y) as component A, and
b) at least one dye as component B,
   the weight ratio of component A to component B in the dye concentrate being in the range from 30:1 to 1:30, preferably in the range from 10:1 to 1:10, more preferably in the range from 3:1 to 1:3 and most preferably in the range from 2:1 to 1:2.

The dye concentrates of the present invention thus utilize an amphiphilic polyisobutene derivative XY as component A. The hydrophilic portion of component A coordinates the dye there being no chemical connection between the dye (component B) and component A.

The hydrophobic portion of component A enters into interaction with the polymeric material, for example polyolefin, to be colored. The amphiphilic component A thus constitutes a kind of “glue” between the polymeric material, for example polyolefin, to be colored and the dye, the interactions between the polymeric material, for example polyolefin, to be colored and the hydrophobic portion of component A on the one hand resting on Van der Waal's interactions and, on the other hand, the interaction between the dye and the hydrophilic portion of component A resting on the principle of coordination.

Component A provides migration-resistant coloration of polymeric materials, for example polyolefins, with dyes. Furthermore, the dye concentrates of the present invention can be used to achieve any desired combination shade hues in high color strength and brilliance. Unlike pigments, the dyes used are customarily not particulate, so that cloggage of fine dies used in the extrusion of yarns for example can be avoided. Furthermore, the use of component A provides excellent dispersion of dye B in polymeric materials, for example polyolefins, so that colorations of high color strength and brilliance are achieved.

In a preferred embodiment of the present invention, the dye concentrate of the present invention comprises at least one polyolefin as component C1 and/or at least one solvent as component C2 as well as components A and B.

In a preferred embodiment, the present invention thus provides a dye concentrate F1 comprising
a) 0.8% to 25% by weight, preferably 1.5% to 15% by weight, more preferably 3% to 10% by weight and most preferably 5% to 10% by weight of component A,
b) 0.8% to 25% by weight, preferably 1.5% to 15% by weight, more preferably 3% to 10% by weight and most preferably 5% to 10% by weight of component B,
c) 50% to 98.4% by weight, preferably 70% to 97% by weight, more preferably 80% to 94% by weight and most preferably 80% to 90% by weight of component C1,
   the sum total of said components A, B and C1 being 100% by weight.

In a further preferred embodiment the present invention provides a dye concentrate F2 comprising
a) 0.8% to 25% by weight, preferably 1.5% to 15% by weight, more preferably 3% to 10% by weight and most preferably 5% to 10% by weight of component A,
b) 0.8% to 25% by weight, preferably 1.5% to 15% by weight, more preferably 3% to 10% by weight and most preferably 5% to 10% by weight of component B,
c) 50% to 98.4% by weight, preferably 70% to 97% by weight, more preferably 80% to 94% by weight and most preferably 80% to 90% by weight of component C2,
   the sum total of said components A, B and C2 being 100% by weight.

It is further possible for the dye concentrate F1 to additionally comprise component C2, preferably in an amount of ≧25% by weight, based on the total amount of components A, B and C1, or for the dye concentrate F2 to additionally comprise component C1, preferably in an amount of ≦10% by weight, based on the total amount of components A, B and C2.

Dye concentrate F1 generally comprises a room temperature solid dye concentrate useful for coloration of polymeric materials, in particular polyolefins, in the form of masterbatches. The solid dye concentrate F1 may be present in any desired form, for example as powder or pellet. Dye concentrate F2 comprises generally a room temperature liquid dye concentrate useful in liquid form for coloration of polymeric materials, in particular polyolefins.

### Component A

Component A comprises at least one polyisobutene derivative composed of at least one hydrophobic block (X) and at least one hydrophilic block (Y). Component A thus comprises amphiphilic polyisobutene derivatives.

The hydrophobic blocks (X) and the hydrophilic blocks (Y) may each be linear, branched or star shaped. The blocks X and Y are linked covalently by suitable linking groups.

Such amphiphilic polyisobutene derivatives useful as component A are known in the prior art and they can be prepared proceeding from starting compounds and methods known to one skilled in the art.

The hydrophobic blocks (X) are composed essentially of isobutene units. They are obtainable by polymerization of isobutene. However, the blocks may also comprise, to a small extent, other comonomers as building components. Such building components can be utilized to fine tune the properties of the blocks. Suitable comonomers, as well as 1-butene and cis- or trans-2-butene include in particular isoolefins having 5 to 10 carbon atoms such as 2-methyl-1-butene-1,2-methyl-1-pentene, 2-methyl-1-hexene, 2-ethyl-1-pentene, 2-ethyl-1-hexene and 2-propyl-1-heptene or vinylaromatics such as styrene and α-methylstyrene, C₁-C₄-alkylstyrenes such as 2-, 3- and 4-methylstyrene and 4-tert-butylstyrene. However, the fraction of such comonomers should not be too large. In general, comonomers should not account for more than 20% by weight, based on the amount of all building components of the hydrophobic blocks (X). The blocks, as well as the isobutene units and comonomers, may further comprise the initiator or starter molecules for starting the polymerization, or fragments thereof. The hydrophobic blocks (X) composed of isobutene units and, if appropriate, aforementioned comonomers may be linear, branched or star shaped.

The hydrophilic block (Y) of component A comprises “polar groups”, and these may comprise not only protic but also aprotic polar groups. Such polar groups comprise for example sulfonic acid radicals, anhydrides, carboxyl groups, carboxamides, carboximides, OH groups, polyoxyalkylene groups, amino groups, epoxides or suitable silanes, which may each be suitably substituted.

Preferably, the hydrophilic blocks (Y) comprise nitrogenous groups linked to one or more chain ends of the hydrophilic blocks (X). The nitrogenous groups may comprise one or more nitrogen atoms. The nitrogen atoms may be incorporated in the terminal group, for example, in the form of amino groups, for example primary, secondary, tertiary and/or aromatic amino groups, or else as amide groups. Preferably, there are 1 to 10 amino groups per terminal group. It is further preferable for there to be primary, secondary and/or tertiary amino groups. There may be for example groups derived from straight-chain or branched alkylenepolyamines. The terminal, nitrogenous group, as well as the nitrogen functionalities, may comprise still other functionalities. Suitable functionalities include in particular oxygenous functional groups, such as OH groups or ether groups.

Component A used according to the present invention may comprise a hydrophobic block (X) which is preferably as defined above and has only one hydrophilic block (Y) at one of its chain ends (X-Y). However, it is also possible for a plurality of hydrophobic blocks (X) to be attached to one terminal hydrophilic block (Y) ((X)ₓ-Y, where x=2, preferably 2 to 5 and more preferably 2 to 3). It is further possible for a linear or essentially linear hydrophobic block (X) to have a hydrophilic block (Y) as a terminal group at both ends. The hydrophobic block (X) may further comprise a star-shaped or branched group having one or more terminal hydrophilic blocks (Y) (X-(Y)_{y}, where y=2, preferably 2 to 5, more preferably 2 to 3). The hydrophobic block (X) comprises at least one, preferably 1 to 5, more preferably 1 to 3 and most preferably one polyisobutene group. As well as the aforementioned branching patterns for the hydrophobic block (X), the subject matter of the present invention comprises further conceivable branching patterns. It will be appreciated that component A in the dye concentrates of the present invention may also comprise mixtures of various polyisobutene derivatives.

Furthermore, the blocks X and Y can be connected to two or more of the respectively other blocks. The blocks X and Y may be linked for example linearly in an alternating arrangement. In principle, any desired number of blocks can be used. In general, however, not more than 8 blocks X and also not more than 8 blocks Y are present in any one particular case. This results in the simplest case in a polyisobutene derivative of the general formula X-Y.

The structure of the polyisobutene derivatives used according to the present invention as component A can be influenced through the selected identity and amount of the starting materials for the blocks X and Y and also through the reaction conditions, in particular the order of addition.

The hydrophobic blocks (X) of the polyisobutene derivatives used according to the present invention generally have a number average molecular weight Mₙ in the range from 200 to 10 000 g/mol. Mₙ is preferably in the range from 300 to 8000 g/mol, more preferably in the range from 400 to 6000 g/mol and most preferably in the range from 500 to 5000 g/mol.

The polyisobutene derivatives used according to the present invention are obtainable by functionalization of reactive polyisobutenes used as starting materials, by providing these reactive polyisobutenes used as starting materials with functional groups in single- or multistage reactions known in principle to one skilled in the art. Reactive polyisobutenes for the purposes of the present invention are polyisobutenes having a very high fraction of terminal α-olefin end groups.

Preferably, the present invention thus comprises dye concentrates comprising a component A obtainable by functionalization of reactive polyisobutene.

Preference is given to using reactive polyisobutenes whose end groups comprise α-olefin groups to at least 85%.

The preparation of reactive polyisobutenes is known and disclosed for example in WO 2004/09654 and WO 2004/35635.

Suitable reactive polyisobutenes are commercially obtainable, for example under the name Glissopal® (BASF AG).

The hydrophilic blocks (Y) are incorporated by functionalizing the reactive polyisobutenes with suitable reagents to form the desired polyisobutene derivatives having at least one hydrophobic block (X) and at least one hydrophilic block (Y). Suitable functionalizations are disclosed for example in WO 2004/09654 and WO 2004/35635 and the references cited therein. The polyisobutene derivatives which according to the present invention are used as component A and which comprise nitrogenous terminal groups as hydrophilic groups (Y) are very advantageously synthesizable by reacting the olefinic end groups of the aforementioned reactive polyisobutenes with compounds which are capable of reacting with the double bond and which in turn are available for a further functionalization. One example is the reaction of polyisobutene with maleic anhydride to form polyisobutenylsuccinic anhydride (PIBSA) or the reaction of polyisobutene with phenols to form polyisobutenylphenols. The polyisobutenes thus functionalized can then be reacted in a second step with nitrogenous compounds and also, if appropriate, further reaction partners to form nitrogenous groups.

Component A more preferably comprises polyisobutene derivatives obtainable by reaction of PIBSA with suitable nitrogenous compounds.

Examples are polyisobutenes having succinimide units. Such polymers are also known as PIBSI. In a further preferred embodiment of the present invention, the dye concentrates of the present invention thus comprise a component A comprising polyisobutenylsuccinimides (PIBSIs).

These polyisobutenylsuccinimides (PIBSIs) are products of the general formula (I):

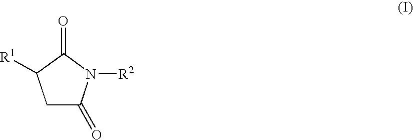

where R¹ and R² are each as defined as follows:

R¹ is a hydrophobic block (X) as defined above;

R² is hydrogen or preferably a hydrocarbyl radical comprising primary, secondary or tertiary amino groups.

Preferred hydrocarbyl radicals R² comprise aliphatic hydrocarbyl radicals having 1 to 60 carbon atoms and preferably having 2 to 30 carbon atoms. They may comprise for example groups derived from straight-chain or branched alkylenepolyamines, preferably groups comprising methylene, ethylene, propylene, butylene, pentylene or hexylene groups. Examples of such groups comprise ω-aminoalkylene groups, for example CH₂—CH₂—NH₂, —CH₂—CH₂—CH₂—NH₂, —CH₂—CH₂-CH₂—CH₂—NH₂, —CH₂—CH—CH₂—CH₂CH₂—NH₂.

Further examples of R² comprise groups of the general formula (II)

—(CH₂)ₓ—NH—[(CH₂)_{y}—NH]_{z}—(CH₂)ₓ—NR⁴R⁵ (II),

where x and y are independently a natural number from 1 to 5 and preferably from 2 to 4 and z is an integral number from 0 to 8. R⁴ and R⁵ are independently H or an alkyl group having 1 to 5 carbon atoms, preferably H or a methyl group, more preferably H. The II radical comprises more preferably the following radical:

—CH₂—CH₂—NH—CH₂—CH₂—NH—CH₂—CH₂—NH—CH₂—CH₂—NH₂.

R² may also comprise a radical derived from polyethyleneimines. R² radicals may optionally comprise still further functional groups, in particular OH groups and/or ether groups. Preferably, however, they are carbon radicals comprising only N-atoms as heteroatoms.

It is likewise possible to use mixtures of various PIBSI derivatives each having different R² and R¹ radicals. PIBSI derivatives are commercially available, for example under the name of Kerocom® PIBSI (BASF AG).

The preparation of the aforementioned PIBSI derivatives is known. They are obtainable in accordance with existing processes by reacting reactive polyisobutene (as defined above) with maleic anhydride to form polyisobutenylsuccinic anhydride (PIBSA). Polyisobutenylsuccinimides (PIBSIs) are obtained by reaction of PIBSA with ammonia and/or amines of the general formula H₂N—R², where R² is as defined above. Details concerning the preparation of such PIBSI derivatives are disclosed for example in DE-A 101 235 33 and also in the as yet unpublished application EP 0 401 869 6.7. The polyisobutene derivatives in question may further comprise by-products, for example unconverted polyisobutene, unconverted PIBSA and also (in addition to the monosuccinimides mentioned above) amic acids (III) or succinamides (IV) and also disuccinimides (V).

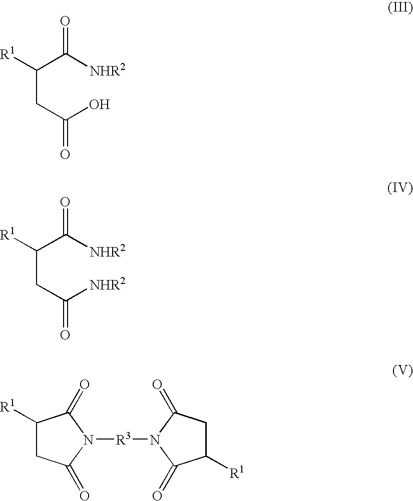

R¹ and R² are each as defined above. R³ comprises a radical which is derived from R² and in which one of the amino groups is incorporated in the second succinimide ring.

The compounds of the formulae (III), (IV) and (V) are also obtainable as main products through appropriate alteration of the reaction conditions. For example, the reaction of PIBSA with the amine in equimolar amounts produces the amic acid (III) which needs higher temperatures, generally 120 to 160° C., to react intermolecularly to form the desired PIBSI derivative of the formula (I). The product ratio is thus easy to control through the chosen reaction temperature.

The possible syntheses for the terminal succinimide polyisobutene derivatives preferably used according to the present invention are hereinbelow indicated by way of example for the reaction of blocks X which form hydrophobic units and are substituted by succinic anhydride groups S, with units Y which form hydrophilic blocks and are substituted by NH groups:

The following groups are preferred for use as units from which to construct the polyisobutene derivatives which according to the present invention are used as component A:

| | |
|---|---|
| HN-[Y]-NH | Y units forming hydrophilic blocks and substituted by |
| | two terminal NH groups |
| [Y]-NH | Y units forming hydrophilic blocks and having only one |
| | NH group |
| [Y]-(NH)ₓ | Y units forming hydrophilic blocks and having x NH |
| | groups, where x is a natural number from 1 to 5, |
| | preferably 1 to 3 and more preferably 1; |
| [X]-S | X polyisobutene units forming hydrophobic blocks and |
| | having a terminal succinic anhydride group S; |
| S-[X]-S | polyisobutene units forming hydrophobic blocks X and |
| | having two terminal succinic anhydride groups S; |
| [X]-S_{y} | polyisobutene units forming hydrophobic blocks X and |
| | having y succinic anhydride groups S, where y is a |
| | natural number from generally 1 to 5, preferably 1 to |
| | 3 and more preferably 1. |

The NH groups may be linked in a manner known in principle with the succinic anhydride groups S to form amide groups. The reaction may be carried out for example by heating in the absence of a solvent. Suitable reaction temperatures range from 80 to 200° C. for example.

Polyisobutene derivatives X-Y used as component A are obtained for example by reaction of one equivalent of HN—[Y]—NH with one equivalent of [X]—S. This is depicted hereinbelow by way of example using the reaction of PIBSA with a diamine of the general formula H₂N—(CH₂—CH₂—NH)ₙ—CH₂—CH₂—NH₂, where z is 0 to 8.

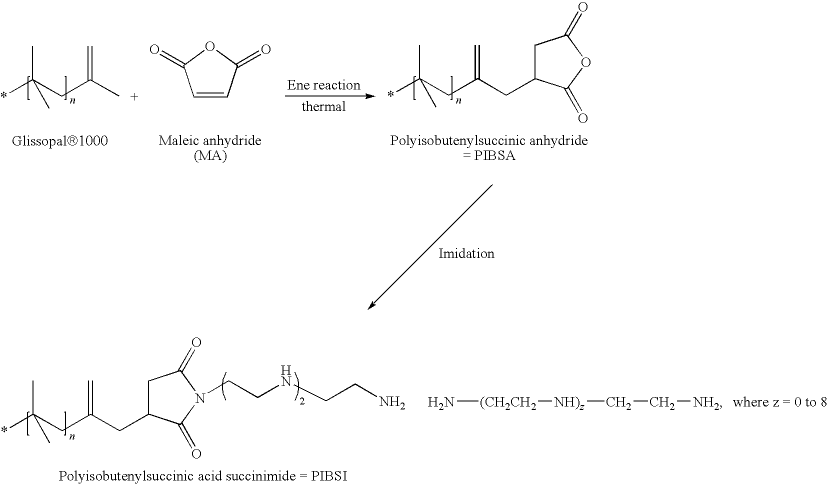

n in the above scheme is a natural number from generally 15 to 20. In general, n is chosen so as to produce the molar masses specified above for the hydrophobic blocks.

Star-shaped or branched polyisobutene derivatives Y—(X), are obtainable by reaction of [Y]—(NH)ₓ with x equivalents of [X]—S.

As mentioned above, one skilled in the art will readily understand that the polyisobutene derivatives obtained as useful for component A may further comprise residues of starting materials, depending on the conditions under which the polyisobutene derivatives were produced. They may also comprise mixtures of various polyisobutene derivatives. Polyisobutene derivatives of the general formula X-Y-X may for example further comprise polyisobutene derivatives of the general formula X-Y and also functionalized and nonfunctionalized polyisobutene. Preferably, the polyisobutene derivatives or mixtures obtained are used for a further application without further purification. Of course, it is likewise possible for the polyisobutene derivatives obtained to be further purified. Suitable methods of purification will be known to one skilled in the art.

As well as polyisobutene derivatives having at least one terminal nitrogenous group, other functionalized polyisobutene derivatives, mentioned above, can be used as component A. The further functionalized polyisobutene derivatives are obtainable for example by the process disclosed in WO 2004/035635.

Polyisobutene derivatives preferably useful as component A are polyisobutene derivatives of the general formula X-Y, the hydrophilic block comprising polyethylene-amine. Particular preference is given to polyisobutenylsuccinimides comprising polyethyleneamine radicals.

### Component B

Component B comprises at least one dye. Component B may be a single dye or a mixture of various dyes. Combination shade colors are obtainable by using mixtures of various dyes. A particular predetermined hue for example is achievable as a result.

In principle, any dye known to one skilled in the art can be used, in particular any dye having good light fastnesses or thermal stability as well as a high color strength and transparency.

Examples of suitable groups of dye are infrared- and/or UV-absorbing dyes, photochromic, thermochromic and fluorescent dyes. Fluorescent dyes here is to be understood as referring not only to the dyes customarily referred to as fluorescent dyes but also optical brighteners. Preferred fluorescent dyes are perylene derivatives, for example dyes of the Lumogen® F range from BASF AG, rhodamines, for example rhodamine B and rhodamine 6G. Preferred suitable optical brighteners are bisstyrylbenzene derivatives, stilbenes, and pyrenes. Further suitable optical brighteners are specified in Ullmann's Encyclopedia of Industrial Chemistry 5th edition, A18, pages 156 to 161.

Infrared- and/or UV-absorbing dyes include such dyes as have very little if any inherent color in the visible region of the electromagnetic spectrum. However, infrared- and/or UV-absorbing dyes for the purposes of the present invention also includes such dyes as absorb in the infrared and/or UV light and at the same time have an inherent color in the visible region of the electromagnetic spectrum.

Suitable dyes are in particular those capable of entering an interaction, for example a complexation, with the component A. Preferred dyes are selected from metalized dyes, cationic dyes, anionic dyes, mordant dyes, direct or substantive dyes, disperse dyes, ingrain dyes, vat dyes, reactive dyes and sulfur dyes. The use of the various dyes is dependent inter alia on the functionalization of the polyisobutene derivatives used as component A in order that particularly good coordination of the dye with the hydrophilic group Y of the polyisobutene derivative may be achieved.

Metalized dyes are particularly suitable. Metalized dyes have one or more metal atoms in the chromophore. They may comprise various chromophores or mixtures of chromophores. Examples of suitable metal complex dyes are those having formulae with the following Color Indices: SY 79, SY 81, SY 82, SO 56, SO 54, SO 99, Sbr. 42, SR 122, SR 118, SR 127, SB 70, SBk 27, SBk 28, SBk 29, SBk 45, RBk 31.

A preferred embodiment utilizes dyes that are transparent in the NIR region.

The amount of dye in the dye concentrate of the present invention is decided by one skilled in the art according to the planned application. The weight ratio of the polyisobutene derivative used according to the present invention (component A) and of the dye (component B) is in the range from 30:1 to 1:30, preferably in the range from 10:1 to 1:10, more preferably in the range from 3:1 to 1:3 and most preferably in the range from 2:1 to 1:2. Further particulars concerning the amount of dye used (component B) in the dye concentrates of the present invention were given above.

In addition to components A and B, the dye concentrates of the present invention preferably comprise at least one polyolefin as component C1 and/or at least one solvent C2.

### Component C1

In principle, any polyolefin known to one skilled in the art is suitable. It may be a homopolymer or copolymer selected from basic C₂-C₈ species such as ethylene, propylene, 1-butene, 2-butene, isobutene, 1-pentene, 1-hexene, 1-heptene, 1-octene, styrene or styrene derivatives such as styrene itself or α-methylstyrene and mixtures thereof.

Component C1 preferably comprises polyolefins comprising C₂- to C₄-olefins as a main constituent, more preferably homo- or copolymers of polyethylene or of polypropylene. Copolymers may be random copolymers or block copolymers. Suitable comonomers in the copolymers are dependent on the particular basic polyolefin species used. Suitable comonomers are thus—depending on basic polyolefin species—ethylene or other α-olefins-dienes such as 1,4-hexadiene, 1,5-hexadiene, 1,6-heptadiene, 2-methyl-1,4-pentadiene, 1,7-octadiene, 6-methyl-1,5-heptadiene or polyenes such as octatriene and dicyclopentadiene. The copolymer fraction that is attributable to the comonomers is generally not more than 40% by weight, preferably not more than 30% by weight, based on the sum total of all the monomers used. For example, the fraction attributable to the comonomers can be in the range from 20% to 30% by weight or 2% to 10% by weight, depending on the application. As mentioned above, homopolymers can be used as well.

A polyethylene-based polyolefin used as component C1 is preferably a linear polyethylene (HDPE, LLDPE). This can be used in the form of a homopolymer or as a random or block copolymer, in which case the usual comonomers, mentioned above, can be used.

In a particularly preferred embodiment the polyolefin used as component C1 is polypropylene. The polypropylene may be a polypropylene homo- or copolymer. Suitable comonomers are mentioned above. Preferred comonomers are ethylene, the aforementioned α-olefins, dienes and/or polyenes. The choice of polypropylene is not restricted. Particular preference is given to polypropylenes having a high melt flow index of for example 25 to 55 g/10 min (measured in accordance with ISO 1133). For example the polypropylene may have an MFI melt flow index (230° C., 2.16 kg) of less than 40 g/10 min. Clear polypropylene is very particularly preferred.

The polyolefins in question may also be blends of various polyolefins, for example of polypropylene and polyethylene.

The polyolefins used as component C1 are obtainable by conventional methods of making, for example by using Ziegler-Natta or metallocene catalysts.

Further details will be known to one skilled in the art and are disclosed for example in “Ullmann's Encyclopedia (of Technical Chemistry), 6^{th} Edition, 2000 Electronic Release” in the “Polyolefins” chapter and the references cited therein.

### Component C2

Generally any solvent compatible with the polymeric material to be colored is suitable. Herein, solvents are generally high-boiling organic compounds whose boiling point is generally above the temperature prevailing at the coloration of the polymeric materials, i.e., preferably above 80° C., more preferably above 120° C., even more preferably above 140° C. and most preferably above 160° C. Solvents herein are in particular low-viscosity, i.e., liquid, polymers and/or oligomers or long-chain hydrocarbons. In general, the viscosity of the polymers and/or oligomers or long-chain hydrocarbons used as a solvent is <5 Pas when measured to DIN 51562. Particular preference for use as solvent is given to polyisobutenes or polyisobutene derivatives having molecular weights Mₙ of generally 200 to 1000, measured by gel permeation chromatography (GPC) against polystyrene standard. Polyisobutenes having the specified molecular weights are very particularly preferred for use as a solvent. The specified low-viscosity polymers or oligomers are commercially available, for example the products of the Glissopal® group of BASF AG.

Component C2 can be present in the dye concentrates of the present invention (cf. dye concentrates F2). It is likewise possible to admix those dye concentrates of the present invention which comprise no component C2 with small amounts of component C2 before they are used for coloring polymeric materials in order to facilitate their incorporation in the polymeric materials.

The dye concentrates of the present invention, as well as the components A, B and if appropriate C1 and/or C2, may comprise further customary additives and auxiliaries as component D. Examples of suitable additives and auxiliaries are plasticizers, antioxidants, antistats, stabilizers, biocides, flame retardants, fillers, dispersants, complexing agents, flow improvers, nucleating agents, and also stabilizers against UV degradation (UV absorbers) and IR absorbers, for example from the class of the terylene and quaterylene derivatives, cyanines, metal dithiolates and ammonium salts.

The dye concentrates of the present invention are obtainable by mixing the components A, B and—if present—C1 and/or C2 and if appropriate D.

Preferably, the polyisobutene derivatives used as component A are intensively mixed with the dyes used as component B and also if appropriate with the polyolefins used as component C1 and/or the solvents used as component C2 and optionally further components D by means of suitable apparatus after being heated until molten. Kneaders, mixers, single-screw extruders, twin-screw extruders or other dispersing assemblies for example are suitable apparatus. The molten dye concentrate composition can be discharged from the dispersing assemblies in a basically known manner via dies. For example, strands can be extruded and chopped into pellets. When the dye concentrate of the present invention comprises component C1—which is preferred—the melt may also be molded directly to form shaped articles, for example by injection molding or blow molding, or it may be extruded through suitable dies to form fibers. It is preferable to produce the dye concentrates of the present invention in one step by heating the components A, B and if appropriate C1 and/or C2 and if appropriate D until molten while at the same time intensively mixing in the aforementioned apparatus. The process for producing the dye concentrates of the present invention can utilize the polyisobutene derivatives (component A) in solution or without a solvent, the use without a solvent being preferred. The solvents mentioned as component C2 are suitable solvents.

The temperature for the mixing/blending of the components A, B and if appropriate C1 and/or C2 and if appropriate D depends in general—when a polyolefin is present as component C1—on the identity of the polyolefin used. The polyolefins should on the one hand soften to a sufficient extent that commixing is possible. On the other hand, they should not become too runny, since it is otherwise impossible to introduce sufficient shearing energy and, moreover, thermal degradation becomes a possible risk. As a general rule the mixing/blending temperatures to produce the dye concentrates of the present invention range from 120 to 300° C. when component C1 is present. It is particularly advantageous here that the polyisobutene derivatives used according to the present invention as component A possess sufficient thermal stability.

The process of the present invention provides the dye concentrates of the present invention which comprise the components A and B in the aforementioned ratios. Preference is given to obtaining dye concentrates which comprise the components A, B and C1 and/or C2 in the aforementioned amounts.

In a further embodiment of the present invention's process for producing preferred dye concentrates comprising the components A, B and C1 and if appropriate D, the polyisobutene derivatives used as component A are incorporated in the polyolefins used as component C1 in a two-stage process. To this end, the polyisobutene derivatives used as component A are mixed only with a portion of the polyolefins used as component C1 by heating. The abovementioned assemblies may be used for mixing. The level of polyisobutene derivatives used as component A which is present in such a polyolefin concentrate can be generally in the range from 3% to 70% by weight, preferably in the range from 5% to 40% by weight, and more preferably in the range from 10% to 30% by weight. The concentrate is subsequently mixed in a second step with the rest of the polyolefins used as component C1 and the dyes used as component B, by heating, and molded according to the intended use. For example, pellets or other shaped articles can be produced for subsequent further processing.

It is further possible to process component A directly with components B and if appropriate C1 and/or C2 and also if appropriate D in the aforementioned dispersing assemblies.

The dye concentrates of the present invention which are produced in accordance with the process described above are useful for coloration of polymeric materials. Transparent, bright and migration-resistant colorations are obtainable.

Suitable polymeric materials may be thermoplastic or thermoelastic materials, of which thermoplastic materials are preferred.

Examples of suitable thermoplastic materials are polyolefins, for example polyethylene, polypropylene and also copolymers comprising polyethylene and/or polypropylene units, polytetrafluoroethylene, polyoxymethylene (POM), polyvinyl chloride, polyvinylidene chloride, cellulose polymers such as cellulose acetate, cellulose acetate butyrate and cellulose acetate propionate, acrylic polymers such as polymethyl methacrylate, styrene-acrylonitrile polymers (SAN), polystyrene, polycarbonate, acrylonitrile-butadiene-styrene-polymers (ABS), methacrylonitrile-butadiene-styrene polymers (MABS), acrylonitrile-styrene-acrylic ester polymers ASA, polyamides such as nylon 6 and nylon 66, polyesters such as polyethylene terephthalate and polybutylene terephthalate or mixtures thereof.

The thermoplastic materials specified may also be blended with other fibers, for example polyester and/or with natural materials such as wool and cotton. Polyolefins are preferred polymeric materials.

Suitable polyolefins for coloration with the dye concentrates of the present invention are the abovementioned polyolefins. That is, preferred polyolefins are polypropylene and its copolymers and clear polypropylene is particularly preferred. The polyolefins to be colored may comprise the same polyolefins as the polyolefins used as component C1 or polyolefins other than component C1. Preferably, the polyolefins to be colored are compatible with and more preferably identical to the polyolefins used as component C.

The present invention accordingly further provides a process for coloration of polymeric materials, preferably polyolefins, by contacting the polymeric materials, preferably polyolefins, with a dye concentrate of the present invention. The temperature at the coloration of the polymeric materials, preferably polyolefins, with the dye concentrates of the present invention depends on the identity of the particular polymeric materials, preferably polyolefins, and the dye used in the dye concentrates. The glass transition temperatures and also melting temperatures of suitable polymeric materials, in particular of polyolefins, will be known to one skilled in the art, or are easily determined in a known manner. In general, the temperature in the present invention's process for coloration of polymeric materials, preferably polyolefins, is at least 80° C., preferably 120 to 200° C. and more preferably 140 to 190° C. Particularly temperatures of 150 to 180° C. will be advantageous for polypropylene homo- and copolymers.

Coloration is thus effected by mixing the polymeric materials, preferably polyolefins, to be colored with the dye concentrate of the present invention at elevated temperature by melting and intensively mixing the components. The same assemblies as specified above with regard to the production of the dye concentrates of the present invention can be used for mixing. The resulting melt can be extruded from the mixing assemblies via dies for example, for example as strands which may be divided into pellets. These colored pellets can be further processed in any desired manner according to processes known to one skilled in the art. However, the molten mass can also be molded directly to form colored shaped articles, for example by injection molding or blow molding, or it can be extruded through suitable dies to form colored fibers.

We have found that, surprisingly, the color strength and also the transparency and brilliance of the colorations of polymeric materials colored with the dye concentrates of the present invention can be still further improved if the polymeric materials, preferably polyolefins, are present in a polymeric composition which, as well as the polymeric materials, comprises at least one block copolymer as component E, comprising at least one hydrophobic block (V), composed essentially of polyisobutene units, and also at least one hydrophilic block (W), composed essentially of oxalkylene units and having an average molar mass Mₙ of at least 1000 g/mol.

The present invention accordingly further provides the present invention's process for coloration of polymeric materials, preferably polyolefins, by contacting the polymeric materials, preferably polyolefins, with at least one dye concentrate of the present invention, wherein the polymeric materials, preferably polyolefins, or the dye concentrate is additionally contacted with at least one block copolymer as component E, comprising at least one hydrophobic block (V) composed essentially of polyisobutene units and also at least one hydrophilic block (W) composed essentially of oxalkylene units and having an average molar mass Mₙ of at least 1000 g/mol.

Preferred block copolymers E and also preferred amounts of block copolymers E in the polymeric compositions are specified hereinbelow.

Without wishing to be tied down to any one theory, we believe that the addition of at least one block copolymer E optimizes the distribution of the dye concentrate of the present invention in the polymeric material. The combination of the dye concentrate of the present invention and of block copolymer E in the present invention's process for coloration of polymeric materials thus makes it possible to achieve optimal results with regard to the color strength, transparency and brilliance of the colorations of polymeric materials colored with the dye concentrates of the present invention.

Contacting the polymeric materials with at least one block copolymer as component E can take place before, after or concurrently with the contacting of the polymeric materials with the dye concentrate of the present invention. Furthermore, component E—in the case of dye concentrate F1—can also be added to the polyolefin used as component C1.
(i) Where the contacting of the polymeric materials, preferably polyolefins, with the block copolymer E takes place before the contacting with the dye concentrate of the present invention, the initial step is to produce a polymeric composition comprising at least one polymeric material, preferably polyolefin, and at least one block copolymer E. Processes for producing suitable polymeric compositions are disclosed for example in the as yet unpublished earlier application bearing the file reference PCT/EP2006/062469. The polymeric compositions obtained are subsequently contacted with the dye concentrates of the present invention in accordance with the abovementioned process for coloring polymeric materials which is in accordance with the present invention.
(ii) As mentioned above, component C1 of dye concentrate F1 may comprise at least one block copolymer E before dye concentrate F1 is produced by mixing the appropriate components. In this case, block copolymer E is contacted with the polyolefin used as component C1. A process for producing polymeric compositions comprising at least one polyolefin and at least one block copolymer E is disclosed for example in the as yet unpublished earlier application bearing the file reference PCT/EP2006/062469. The polymeric mixture obtained is contacted with the components A and B to produce the dye concentrate F1. This dye concentrate F1 in accordance with the present invention can subsequently be contacted with at least one polymeric material, preferably polyolefin, to obtain the colored polymeric compositions of the present invention.
(iii) Where the contacting of the polymeric materials with the at least one block copolymer E takes place after the contacting with the at least one dye concentrate, it is preferable for the polymeric material to be first colored with the dye concentrate as described above. This is followed by the addition of the block copolymer E and the further processing in accordance with processes known to one skilled in the art.
(iv) In a further embodiment, the contacting of the polymeric materials with the block copolymer E takes place concurrently with the contacting of the polymeric materials with the dye concentrate of the present invention. In this embodiment, the polymeric materials, preferably polyolefins, to be colored, the at least one dye concentrate of the present invention and the at least one block copolymer E are mixed, preferably at elevated temperature, the components being melted and intensively mixed. Coloration is preferably effected as described above with regard to the process for coloring the polymeric materials with the dye concentrate of the present invention, except that the block copolymer E is also added.

The contacting of the polymeric materials with at least one block copolymer as component E is preferably effected in accordance with one of the embodiments (ii) or (iv).

The present invention further provides colored polymeric compositions composed of
i) at least one dye concentrate of the present invention,
ii) at least one polymeric material, preferably polyolefin.

The concentration of the at least one dye (component B of the dye concentrate of the present invention) in the colored polymeric compositions is generally in the range from 0.01% to 5% by weight, preferably in the range from 0.05% to 1.5% by weight and more preferably in the range from 0.1% to 1.0% by weight.

Preferred dye concentrates and preferred polymeric materials are mentioned above.

In a preferred embodiment, the colored polymeric compositions of the present invention, as well as the at least one dye concentrate and the at least one polymeric material, preferably polyolefin, comprise:
iii) at least one block copolymer as component E comprising at least one hydrophobic block (V) composed essentially of polyisobutene units and also at least one hydrophilic block (W) composed essentially of oxalkylene units and having an average molar mass Mₙ of at least 1000 g/mol.

As mentioned above, the addition of block copolymer E provides optimal results with regard to the color strength, transparency and brilliance of the colorations of polymeric materials, preferably polyolefins, colored with the dye concentrates of the present invention.

### Component E

The block copolymer used as component E comprises at least one hydrophobic block (V) and at least one hydrophilic block (W). The blocks (V) and (W) are connected to each other by means of suitable linking groups. They may each be linear or else comprise branching.

Such block copolymers are known and their preparation can be effected proceeding from starting compounds and methods known in principle to one skilled in the art. Suitable block copolymers E and also suitable hydrophilic and hydrophobic blocks and their linking to form the block copolymers E are disclosed for example in the as yet unpublished earlier application bearing the file reference PCT/EP2006/062469.

The hydrophobic blocks (V) correspond essentially to the hydrophobic blocks (X) of component A, which are described above. The hydrophobic blocks (V) and the hydrophobic blocks (X) independently have the meanings described with regard to the hydrophobic blocks (X). Suitable hydrophobic blocks are further disclosed in the as yet unpublished earlier application bearing the file reference PCT/EP2006/062469. Particularly preferred hydrophobic blocks (V) are polyisobutenes functionalized with succinic anhydride groups (polyisobutenylsuccinic anhydride, PIBSA).

The hydrophilic blocks (W) are composed essentially of oxalkylene units. Suitable hydrophilic blocks are disclosed in the as yet unpublished earlier application bearing the file reference PCT/EP2006/062469.

In general, the hydrophilic blocks comprise ethylene oxide units —(CH₂)₂—O— and/or propylene oxide units —CH₂—CH(CH₃)—O—, as main components, while higher alkylene oxide units, i.e., those having more than 3 carbon atoms, are only present in small amounts to fine tune the properties. The blocks may be random copolymers, gradient copolymers, alternating copolymers or block copolymers composed of ethylene oxide units and propylene oxide units. The amount of higher alkylene oxide units should not exceed 10% by weight and preferably not exceed 5% by weight. The blocks are preferably blocks comprising at least 50% by weight of ethylene oxide units, preferably 75% by weight and more preferably at least 90% by weight of ethylene oxide units. Most preferably, the blocks are pure polyethylene blocks.

The block copolymers E may preferably be synthesized by the hydrophilic blocks (W) first being separately synthesized and reacted in a polymer-analogous reaction with the functionalized polyisobutenes to form block copolymers E.

The building components for the hydrophilic and hydrophobic blocks have complementary functional groups, i.e., groups capable of reacting with each other to form linking groups.

The functional groups of the hydrophilic blocks (W) are of course preferably OH groups, but may also be for example primary or secondary amino groups. OH groups are particularly useful complementary groups for reaction with PIBSA, the preferred hydrophobic block (V).

The synthesis of the blocks (W) can be effected by reacting polyisobutenes comprising polar functional groups (i.e., blocks (V)) directly with alkylene oxides to form blocks (W).

The structure of the block copolymers E can be influenced through the identity and amount of the starting materials for the blocks (V) and (W) and also through the reaction conditions, in particular the order of addition.

The blocks (V) and (W) may be in the terminal position; that is, they may be attached to one other block only, or they may be attached to two or more other blocks. The blocks (V) and (W) may be linked with each other for example linearly in an alternating arrangement. In principle, any desired number of blocks can be used. Generally, however, no more than 8 each of blocks (V) and (W) will be present. This results in the simplest case in a diblock copolymer of the general formula VW. There may further be triblock copolymers of the general formula VWV or WVW. It is self-evidently also possible for a plurality of blocks to follow each other, for example VWVW, WVWV, VWVWV, WVWVW or VWVWVW.

There may further be star-shaped and/or branched block copolymers or else comblike block copolymers wherein, in each case, more than two blocks (V) are attached to one block (W) or more than two blocks (W) are attached to one block (V). For example, there may be block copolymers of the general formula VWₘ or WVₘ, where m is a natural number ≧3, preferably 3 to 6 and more preferably 3 or 4. It will be appreciated that a plurality of blocks (V) and (W) may also follow each other in the arms or branches, for example V(WV)ₘ or W(VW)ₘ. The possible syntheses are depicted hereinbelow for OH groups and succinic anhydride groups (referred to as S) by way of example without this invention being thereby restricted to the use of such functional groups.

| | |
|---|---|
| HO-[W]-OH | Hydrophilic blocks having two OH groups |
| [V]-OH | Hydrophilic blocks having one OH group only |
| [W]-(OH)ₓ | Hydrophilic blocks having x OH groups (x ≧ 3) |
| [V]-S | Polyisobutene having one terminal group S |
| S-[V]-S | Polyisobutene having two terminal groups S |
| [V]-S_{y} | Polyisobutene having y groups S (y ≧ 3) |

The OH groups may be linked together with the succinic anhydride groups S in a manner known in principle to form ester groups. The reaction may be carried out for example by heating in the absence of a solvent. Suitable reaction temperatures range for example from 80 to 150° C.

Triblock copolymers V-W-V are obtained for example in a simple manner by reaction of one equivalent of HO—[W]-OH with two equivalents of [V]-S. This is depicted hereinbelow with complete formulae using the reaction of PIBSA and a polyethylene glycol as an example:

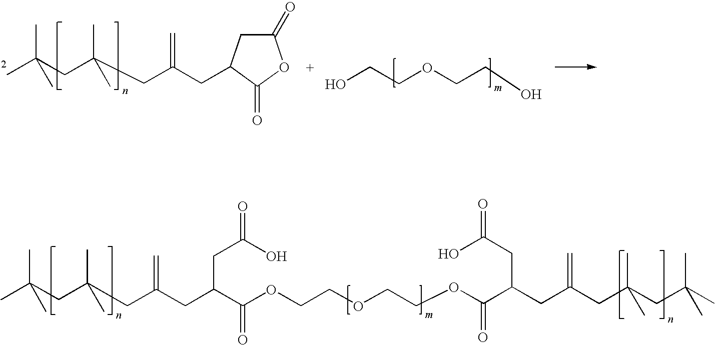

Here, n and m are each independently a natural number. They are chosen by one skilled in the art so as to result in the above-defined molar masses for the hydrophobic and hydrophilic blocks respectively.

Star-shaped or branched block copolymers WVₓ are obtainable by reaction of [W]-(OH)ₓ with x equivalents of [V]-S.

A person skilled in the art of polyisobutenes will readily understand that the block copolymers obtained may still comprise residues of starting materials, depending on the manufacturing conditions. They may also comprise mixtures of various products. Triblock copolymers of the formula VWV may for example further comprise diblock copolymers VW and also functionalized and unfunctionalized polyisobutene. Advantageously, these products can be utilized for the application without further purification. Of course, however, the products may additionally be purified. Methods of purification will be known to one skilled in the art.

Preferred block copolymers for executing this invention are triblock copolymers of the general formula VWV or their mixture with diblock copolymers VW and also, if appropriate, by-products.

The block copolymer which is used as component E and which, in one embodiment of the present invention, may be present in the colored polymeric compositions of the present invention is generally present in the colored polymeric compositions, if at all, in an amount of 0.01% to 10% by weight, preferably 0.03% to 5% by weight and more preferably 0.05% to 3% by weight, based on the total mass of the colored polymeric composition.

Preferred colored polymeric compositions comprising component E are thus composed of:
i) 0.1% to 15% by weight, preferably 0.3% to 10% by weight and more preferably 0.5% to 8% by weight of at least one dye concentrate of the present invention,
ii) 75% to 99.89% by weight, preferably 85% to 99.67% by weight and more preferably 89% to 99.45% by weight of at least one polymeric material, preferably polyolefin,
iii) 0.01% to 10% by weight, preferably 0.03% to 5% by weight and more preferably 0.05% to 3% by weight of at least one block copolymer as component E, comprising at least one hydrophobic block (V) composed essentially of polyisobutene units and also at least one hydrophilic block (W) composed essentially of oxalkylene units and having an average molar mass Mₙ of at least 1000 g/mol.

Preferred dye concentrates, polymeric materials and block copolymers (component E) are mentioned above. The polymeric compositions may further comprise suitable additives and auxiliaries, component D. Substances useful as component D are specified above.

The colored polymeric compositions of the present invention may be present in any desired form, for example in the form of moldings, packaging materials, films, or as fibers, yarns, wovens, nonwovens, knits or other textile materials. Suitable processes for using polymers or polymeric compositions to produce moldings, films, packaging, fibers or descendant yarns, wovens, nonwovens and/or other textile materials will be known to one skilled in the art.

The present invention accordingly further provides moldings, packaging materials, films or fibers composed of the colored polymeric composition of the present invention.

As well as by the aforementioned processes for producing colored polymeric compositions and also pellets, moldings and fibers therefrom, the colored polymeric compositions of the present invention can be produced by other processes by utilizing the dye concentrates of the present invention.

The present invention accordingly further provides for the use of the dye concentrates of the present invention for coloration of polymeric materials or of polymeric compositions comprising, as well as the polymeric materials, at least one block copolymer as component E as described above. Preferred polymeric materials and dye concentrates and also preferred block copolymers are specified above.

The polymeric materials, in particular polyolefins, colored with the dye concentrates of the present invention feature more intensive, more brilliant and more transparent colorations than pigment-colored polymeric materials, in particular polyolefins, in accordance with prior art processes. The desired depths of shade are achievable with distinctly less colorant than when pigments are used. Moreover, compared with other dye-colored polymeric materials, in particular polyolefins, they have better resistances to migration. Furthermore, coloration of the polymeric materials is possible in any desired (combination shade) hues. The hue remains brilliant, in contradistinction to pigment coloration.

In a further embodiment, the present invention provides for the use of the present invention's dye concentrates for coloration of polymeric materials used for transmission laser welding.

Suitable polymeric materials will be known to one skilled in the art and are mentioned above. Preferred polymeric materials are polyolefins such as polyethylene and polypropylene and also copolymers comprising polyethylene and/or polypropylene units, polycarbonates, polymethyl methacrylate, polyesters such as polyethylene terephthalate, polyamides, polystyrene, ABS, MABS, SAN, polyvinyl chloride, polytetrafluoroethylene, polyoxymethylene or mixtures thereof. The dye concentrates of the present invention in this embodiment comprise at least one dye B that is transparent in the NIR region, particular preference is given to coloring the polymeric materials black, i.e., the at least one dye B comprises more preferably at least one black dye or a black trichromatic dye blend that is transparent in the NIR region. These black polymeric materials are of particular interest, since carbon black typically used for coloring polymeric materials black absorbs in the NIR region and prior art black dyes or dye blends are highly prone to migrate, which is undesirable.

The present invention further provides colored polymeric materials used for transmission laser welding, comprising at least one inventive dye concentrate comprising at least one dye B that is transparent in the NIR region, preferably at least one black dye B. Suitable polymeric materials are specified above.

The present invention further provides for the use of the present invention's dye concentrates comprising at least one black dye B that is transparent in the NIR region for coloring polymeric materials black. Suitable polymeric materials are specified above.

The polymeric materials colored black with the present invention's dye concentrates comprising at least one dye B that is transparent in the NIR region have the advantage over polymeric materials colored black with carbon black that they do not heat up as much as materials colored with carbon black, since carbon black absorbs in the visible region and in the IR region. Trichromatic black dye blends typically used in the prior art tend to migrate in the colored materials. By comparison, the dye concentrates of the present invention are advantageous in that they resist migration.

The present invention further provides polymeric materials colored black and comprising at least one inventive dye concentrate comprising at least one black dye B that is transparent in the NIR region. Suitable materials are specified above.

Examples of suitable black dyes B are SBk 27, SBk 28, SBk 29, SBk 45 and RBk 31.

The dye concentrates of the present invention can be used in a further embodiment of the present invention to construct multilayered systems.

The multilayered systems comprise at least two layers I and II. The first layer I is generally an NIR-reflective substrate, for example metals, in particular aluminum, iron or steel, or white layers, in particular any desired TiO₂-coated substrate. Suitable substrates are for example polymeric materials, suitable polymeric materials being specified above, for example POM, composite materials and wood.

The second layer II is composed of a material comprising at least one dye concentrate of the present invention. Suitable materials are for example the polymeric materials specified above. Preferably, the second layer II comprises at least one inventive dye concentrate comprising at least one dye B that is transparent in the NIR region. It is particularly preferable for the at least one dye B to be transparent in the NIR region and black. Suitable NIR-transparent black dyes are specified above.

The present invention accordingly further provides a multilayered system composed of
i) a first layer I in the form of an NIR-reflective substrate;
ii) a second layer II composed of a material comprising at least one dye concentrate of the present invention.

Suitable and preferred layers I and II, suitable and preferred materials for layer II and also suitable and preferred dye concentrates in accordance with the present invention are specified above.

The multilayered system, as well as layers I and II, may comprise one or more further layers, for example clearcoats of any kind and/or further polymeric layers, suitable polymeric materials including for example the polymeric materials specified above.

The dye concentrates of the present invention may further be used in security applications.

The present invention accordingly further provides for the use of the present invention's dye concentrates for forgeryproof marking of articles, wherein the dye concentrates are generally used as an IR-transparent component.

Suitable dye concentrates are particularly those which comprise at least one dye B that is transparent in the NIR region.

Suitable articles for marking with the dye concentrates of the present invention include for example forgeryproof markings such as markings of bank notes, shares and other securities, check and credit cards, identification papers and markings on packaging such as packaging for high ticket semi-luxury food and tobacco products, markings on tickets of admission, entrance tickets, coupons and luxury goods. The forgeryproof markings generally serve to prevent forgeries and/or to prevent brand piracy.

The articles produced with the present invention's dye concentrates that comprise at least one dye B that is transparent in the NIR region become transparent under NIR light, i.e., they become invisible. It is thus possible for example for a motif applied with a customary carbon black pigment to be fully covered with an NIR-transparent black dye concentrate of the present invention. Viewed under NIR light, the original motif becomes visible again.

The present invention further provides for the use of polyisobutene derivatives A composed of at least one hydrophobic block (X) and at least one hydrophilic block (Y) for migration-resistant coloration of polymeric materials, preferably polyolefins, by incorporation of an inventive dye concentrate comprising at least one dye B and at least one polyisobutene derivative A in a nonaqueous way. One embodiment of the present invention concerns the aforementioned use wherein additionally a block copolymer is incorporated as component E as defined above in the polymeric materials, preferably polyolefins.

Suitable dye concentrates and also suitable processes for coloration of polymeric materials in a nonaqueous way, i.e., not in an aqueous dyeing liquor, and also suitable polymeric materials and suitable block copolymers (component E) are specified above.

The examples which follow additionally elucidate the present invention.

### EXAMPLES

The PIBSA₁₀₀₀ used in the examples which follow is commercially available from BASF AG under the trade name of Glissopal®. The DIN 51562 viscosity at 80° C. is 1400 mm²/s.

### A) Preparation of Polyisobutene Derivatives Used as Coloring Auxiliaries

### Polyisobutene Derivatives:

Preparation of polyisobutene derivatives of X-Y structure from PIBSA 1000 and tetraethylenepentamine or triethylenetetramine

Polyisobutene Derivative 1:

Reaction of PIBSA₁₀₀₀ (saponification number SN=86 mg/g KOH) with tetraethylene-pentamine

A 2 I four neck flask is charged with 582 g of PIBSA (85% α-olefin fractions, Mₙ=1000; DP=1.70; based on the polyisobutene) and 63.8 g of ethylhexanol under an inert gas atmosphere (N₂ protection). After heating to 140° C., 99.4 g of tetraethylpentamine are added dropwise. On completion of the addition the temperature is raised to 160° C. and maintained at 160° C. for 3 h. During the reaction, some volatile constituents distill over. For completion, the pressure is reduced to 500 mbar for 30 min toward the end of the reaction. This is followed by cooling down to room temperature.

IR spectrum: NH vibration at 3295, 1652 cm⁻¹, C═O stretching vibration of succinimide scaffold at 1769, 1698 cm⁻¹. Further vibrations of PIB scaffold: 2953, 1465, 1396, 1365 and 1238 cm⁻¹.

Polyisobutene derivatives 2 to 6:

Reaction of PIBSA₁₀₀₀ (saponification number SN=95 mg/g KOH) with tetraethylenepentamine (polyisobutene derivatives 2, 3 and 4) or triethylenetetramine (polyisobutene derivatives 5 and 6).

The polyisobutene derivatives 2 to 6 are prepared according to Examples 3 to 7 in DE 101 23 553 A1. Examples 2, 3, 4, 5 and 6 of the present invention correspond to Examples 3, 4, 5, 6 and 7 respectively of DE 101 23 553 A1.

### Polyisobutene Derivative 7:

Reaction of PIBSA₁₀₀₀ (saponification number SN=170 mg/g KOH) with tetraethylenepentamine

The polyisobutene derivative 7 is prepared according to Example 2 (product number 7) of EP0271 937A2.

### Polyisobutene Derivative 8:

Reaction of PIBSA₁₀₀₀ with triethylenetetramine

The polyisobutene derivative 8 is prepared according to Example 1 of WO 98/12282, except that PIBSA₁₀₀₀ (Glissopal®) is used instead of Indopol® H-100 from Amoco Chemical Company.

Preparation of polyisobutene derivatives of Y-X-Y structure from PIBSA₁₀₀₀ and tetraethylenepentamine or triethylenetetramine

### Polyisobutene Derivatives 9 to 12:

Reaction of PIBSA₁₀₀₀ (saponification number SN=95) with tetraethylenepentamine (polyisobutene derivatives 9 and 10) or triethylenetetramine (polyisobutene derivatives 11 and 12).

The polyisobutene derivatives 9 to 12 are prepared according to Examples 8 to 11 of DE 101 23 553 A1. Examples 9, 10, 11 and 12 of the present invention correspond to Examples 8, 9, 10 and 11 respectively of DE 101 23 553 A1.

### B) Coloring Tests

### Production of Inventive Coloring Concentrates:

The following polymers are used for the tests:

Polypropylene: Moplen HP 561S (from Basell), Moplen HP 561S is a homopolypropylene (metallocene catalysis) having a very narrow molecular weight distribution. It is specifically suitable for spinning continuous filaments and nonwovens. Product data of homopolypropylene without further additions:

| Properties | Method | Unit | Values |
|---|---|---|---|
| Melt flow rate | ISO 1133 | g/10 min | 33 |
| Tensile strength | ISO 527-1, -2 | MPa | 35 |
| Elongation | ISO 527-1, -2 | % | 9 |
| Elongation at break | ISO 527-1, -2 | % | >50 |
| Softening point | ISO 306 | ° C. | 152 |
| Temperature of deflection | ISO 75B - 1, -2 | 5 C. | 86 |
| under load | | | |
| Density | ISO 1183 | G/cm³ | 0.89-0.91 |

In each of two different tests 5% by weight of the abovementioned polyisobutene derivatives 1 to 12 are added to 85% of polypropylene pellet. At the same time, 10% of copper phthalocyanine metal complex dye (SB 70 (Color Index: Solvent Blue 70)) is extruded in an extruder with the mixture at 180° C. The colored polymeric extrudates obtained are cut into pellets. For comparison, a sample of the same dye with the comparative polymer without polyisobutene derivative 1 is also produced. In addition, a comparable pigment is incorporated in the polymeric matrix in a third formulation.

The tests are carried out in a twin-screw extruder at a barrel temperature of 180° C. and 200 rpm. Die outputs are 1×4 mm.

The dye is mixed together with the polypropylene pellet and introduced by feed screw into the front end of the extruder. The throughput is 5 kg/h. The particular polyisobutene derivative is liquefied at 80° C. and added at 250 g/h into the extruder from above. The metering pump can be adjusted to a throughput between 100-300 g/h in order that the concentration of the particular polyisobutene derivative in the formulation can be set.

### Incorporation of Coloring Concentrate in Uncolored Polyolefin:

The coloring concentrate is incorporated by means of extruders in the desired concentration in the colorless polymers and mixed together at about 180° C. A dye concentration of 0.01% to 5% in the final formulation is chosen. The composition of a polymeric composition suitable for processing by injection molding is set out hereinbelow by way of example:

### B1: Injection Molding

0.05% by weight of copper phthalocyanine metal complex dye used
0.025% by weight of PIBSI 1000 (polyisobutene derivative 1)
0.425% by weight of polypropylene (Moplen HP 5615), and
99.50% by weight of highly transparent polypropylene comprising nucleating agent, as colorless polymer

### C) Preparation of Block Copolymers Used as Coloring Auxiliaries

### Block Copolymer 1:

Preparation of a block copolymer of VWV structure from PIBSA 550 and polyethylene glycol 1500

Reaction of PIBSA₅₅₀ (molar mass Mₙ 550, saponification number SN=162 mg/g KOH) with Pluriol® E1500 (polyethylene oxide, Mₙ=1500)

A 4 I three neck flask equipped with internal thermometer, reflux condenser and nitrogen tap is charged with 693 g of PIBSA (Mₙ=684; dispersity index DP=1.7) and 750 g of Pluriol® E1500 (Mₙ=1500, DP=1.1). In the course of heating to 80° C., the flask is evacuated and blanketed with N₂ 3×. The reaction mixture is heated to 130° C. and held at 130° C. for 3 h. Thereafter, the product is cooled down to room temperature. The following spectra are recorded:

IR Spectrum (KBr) in cm⁻¹:

OH stretching vibrations at 3308; C—H stretching vibrations at 2953, 2893, 2746; C═O stretching vibration at 1735; C═C stretching vibration at 1639; further vibrations of PIB scaffold: 1471, 1390, 1366, 1233; ether vibration of Pluriol at 1111.

1-H NMR spectrum (CDCl₃, 500 MHz, TMS, room temperature) in ppm:

4.9-4.7 (C═C from PIBSA); 4.3-4.1 (C(O)—O—CH₂—CH₂—); 3.8-3.5 (O—CH₂—CH₂-O, PEO chain); 3.4 (O—CH₃); 3.1-2.9; 2.8-2.4; 2.3-2.1; 2.1-0.8 (methylene and methine of PIB chain)

### Block Copolymer 2

Preparation of a block copolymer of VWV structure from PIBSA 1000 and polyethylene glycol 6000

Reaction of PIBSA₁₀₀₀ (saponification number SN=86 mg/g KOH) with Pluriol® E6000 (polyethylene oxide, Mₙ≈6000)

A 4 I three neck flask equipped with internal thermometer, reflux condenser and nitrogen tap is charged with 783 g of PIBSA (Mₙ=1305; DP=1.5) and 1800 g of Pluriol® E6000 (Mₙ≈6000, DP=1.1). In the course of heating to 80° C., the flask is evacuated and blanketed with N₂ 3×. The mixture is subsequently heated to 130° C. and held at 130° C. for 3 h. Thereafter, the product is allowed to cool down to room temperature and is analyzed spectroscopically.

IR spectrum (KBr) in cm⁻¹:

OH stretching vibration at 3310; C—H stretching vibration at 2956, 2890, 2745; C═O stretching vibration at 1732; C═C stretching vibration at 1640; further vibrations of PIB scaffold: 1471, 1388, 1365, 1232; ether vibration of Pluriol at 1109.

1-H NMR spectrum (CDCl₃, 500 MHz, TMS, room temperature) in ppm:

Comparable to Example 1, different intensities: 4.9-4.7 (C═C from PIBSA); 4.3-4.1 (C(O)—O—CH₂—CH₂—); 3.8-3.5 (O—CH₂—CH₂-O, PEO chain); 3.4 (O—CH₃); 3.1-2.9; 2.8-2.4; 2.3-2.1; 2.1-0.8 (methylene and methine of PIB chain)

### D) Coloring Tests

### Production of an Inventive Dye Concentrate

The inventive dye concentrates are produced as described under B), the polypropylene pellet comprising the block copolymer 2 in the hereinbelow specified amount.

The dye concentrate comprises 10% by weight of a copper phthalocyanine metal complex dye with the Color Index Solvent Blue 70 (SB 70) and 5% by weight of PIBSI 1000 (polyisobutene derivative 1), 5% by weight of block copolymer 2 and also 80% by weight of polypropylene pellet (Moplen HP 5615).

### Incorporation of Dye Concentrate in Uncolored Polyolefin

Incorporating (extending) the dye concentrate in uncolored high transparency polypropylene comprising nucleating agent by coextrusion of dye concentrate and of high transparency polypropylene at 180° C. Compositions for producing polymeric fibers and injection moldings are produced that comprise various amounts of the dye concentrate in relation to the high transparency polypropylene:

### D1: Polymeric Fibers

The colored polymer comprises:
0.4% by weight of the copper phthalocyanine metal complex dye used
0.2% by weight of PIBSI 1000 (polyisobutene derivative 1)
0.2% by weight of block copolymer used (block copolymer 2)
3.2% by weight of polypropylene (Moplen HP5615), and
96.0% by weight of high transparency polypropylene comprising nucleating agents.

### D2: Injection Molding

0.05% by weight of the copper phthalocyanine metal complex dye used
0.025% by weight of PIBSI 1000 (polyisobutene derivative 1)
0.025% by weight of block copolymer used (block copolymer 2)
0.40% by weight of polypropylene (Moplen HP 5615), and
99.50% by weight of high transparency polypropylene comprising nucleating agents.

### Assessment of Injection Moldings Obtained:

The evaluation is done with reference to the following parameters:
Depth of shade (or color strength) achieved: compared with a pigment-colored color concentrate, about 5-10 times less colorant is needed to obtain the desired depth of shade.
Migration fastness: to determine migration fastness, the particular inventive and comparative injection molding is contacted with an uncolored or white PVC film and loaded with a weight. The two polymers in mutual contact are stored in a drying cabinet at 60° C. for 10 days. The staining of the uncolored or white PVC film by the injection molding is assessed. The particular color concentrates with polyisobutene derivative have a fastness of 4-5, the comparative batch without polyisobutene derivative has a fastness of 2.

Migration fastness was determined by the following method in accordance with NF EN ISO 183:2000:

The exudation/diffusion of a dye was determined qualitatively following its final application.

### Basic Principle:

Close physical contact of a colored test section rich in throat depths on a sheet or plate of the test material with two acceptor substances and subsequent heating of the entire system under precisely defined conditions.

### Apparatus:

A drying cabinet with air circulation and adjustable temperature setting to +/−2° C. between 50 and 100° C.

Two glass plates having a surface area that is larger than the size of the test section. Two acceptor substances on a sheet having a surface area which exactly matches that of the glass plates and a thickness of about 1 mm:
a flat white filter made of paper
calendered plastisol

### Procedure:

a test section to be tested is applied to a square of the calendered plastisol and covered with a white and dry filter made of paper and a close physical contact is established between the various parts by pressure. This assembly is slid in between two glass plates.
adhesively bond the ends of the entire assembly together to ensure permanent contact.
prepare a comparative sample (noncolored test section made of the same material) by the same method.
place the entire assembly in a drying cabinet at 70° C.+/−2° C. for 72 hours.

Subsequently, examination of the various traces which have formed on the plastisol or on the paper filter.

### Presentation of Result:

The result for each absorbent square is assessed according to the following criteria:

1: impeccable support
2: hazy dots (spots without clear contour)
3: small spots
4: large spots
5: complete and uniform coloration
Transparency: the injection molding colored with the dye concentrates of the present invention exhibits excellent transparency on visual inspection, the injection moldings colored with pigments exhibit substantial clouding in transmitted light.
Brilliance: the injection molding colored with the dye concentrates of the present invention exhibits excellent brilliance on visual inspection, the injection moldings colored with pigments have less brilliant hues.
Miscibility: the dyes used can be mixed to form any desired hue (TRICHROMISM), whereas the pigments can only be used close to their original hue.

### E) Comparative Examples

The polymeric compositions B1 and D2 are injection molded to produce plaques whose color strength is colorimetrically compared in transmission (using a Datacolor calorimeter) with correspondingly produced injection-molded plaques produced from a comparative polymeric composition.

The comparative polymeric composition comprises 0.05% by weight of a blue colorant from Milliken wherein the chromophoric group is covalently attached to a polyalkyleneoxy radical, as disclosed in EP-A 0215 322, EP-A 0445 926, EP-A 0 398 620 and EP-A 0 437 107. The dye is commercially available (Cleartint® PP Blue 9805). The other components (polypropylene and high transparency polypropylene comprising nucleating agents) correspond to the components used in inventive examples B1 and D2. The amounts of the individual components of the comparative polymeric composition are indicated hereinbelow:

### VI: Comparative Polymeric Composition

0.05% by weight of the blue colorant used from Milliken
0.45% by weight of polypropylene (Moplen HP 5615), and
99.50% by weight of high transparency polypropylene comprising nucleating agents.

The polymeric compositions B1, D2 and the comparative polymeric composition thus each comprise 0.05% by weight of the colorant used.

The table which follows lists the results of the color strength comparison of the injection-molded plaques produced from the three blue polymeric compositions (the color strength is measured calorimetrically in transmission (using a Datacolor calorimeter); the values obtained are relative values):

| | | Color strength |
|---|---|---|
| | | (colorimetric¹⁾ |
| Composition | | assessment) |
| B1 | Inventive composition without component E | 100 |
| D2 | Inventive composition with component E | 135 |
| V1 | Comparative polymeric composition | 13 |

¹⁾relative values

The calorimetrically determined values reported in the table above agree very well with the visual assessment of color strength.

The results show a distinct improvement in color strength for the inventive compositions over the prior art composition.

1-23. (canceled)

24. A dye concentrate F1, comprising:
a) 0.8% to 25% by weight of at least one polyisobutene derivative composed of at least one hydrophobic block X and at least one hydrophilic block Y as component A,
b) 6% to 25% by weight of at least one dye as component B, and
c) 50% to 93.2% by weight, of at least one polyolefin as component C1
the sum total of said components A, B and C1 being 100% by weight; or
a dye concentrate F2, comprising:
a) 0.8% to 25% by weight of component A,
b) 6% to 25% by weight of component B, and
c) 50% to 93.2% by weight of a solvent as component C2,
the sum total of said components A, B and C2 being 100% by weight,
the weight ratio of component A to component B in the dye concentrate being in the range from 30:1 to 1:30.

25. The dye concentrate F1 or F2 according to claim 24, comprising, in the case of the dye concentrate F1,
a) 1.5% to 15% by weight of component A,
b) 6% to 15% by weight of component B, and
c) 70% to 92.5% by weight of component C1,
the sum total of said components A, B and C1 being 100% by weight;
or, in the case of the dye concentrate F2,
a) 1.5% to 15% by weight of component A,
b) 6% to 15% by weight of component B, and
c) 70% to 92.5% by weight of component C2,
the sum total of said components A, B and C2 being 100% by weight.

26. The dye concentrate according to claim 24, wherein said component A is obtainable by functionalization of reactive polyisobutene.

27. The dye concentrate according to claim 24, wherein said component A is a polyisobutenylsuccinimide.

28. The dye concentrate according to claim 24, wherein said component B is a metalized dye.

29. The dye concentrate according to claim 24, wherein the polyolefins used as component C1 are selected from the group consisting of homo- or copolymers composed of C₂ to C₈ units and/or styrene or styrene derivatives.

30. The dye concentrate according to claim 24, wherein the solvent used as component C2 is a polyisobutene having a molecular weight Mₙ in the range from 200 to 1000.

31. A process for producing the dye concentrate according to claim 24, which comprises mixing said components A, B and C1 or C2 with each or one another.

32. A process for coloration of a polymeric material, by contacting said polymeric material, with a dye concentrate according to claim 24.

33. The process according to claim 32, wherein said polymeric material, or said dye concentrate, is additionally contacted with at least one block copolymer as component E, comprising at least one hydrophobic block (V) composed essentially of polyisobutene units and at least one hydrophilic block (W) composed essentially of oxalkylene units and having an average molar mass Mₙ of at least 1000 g/mol.

34. A colored polymeric composition composed of:
i) at least one dye concentrate according to claim 24, and
ii) at least one polymeric material.

35. The colored polymeric composition according to claim 34, further comprising:
iii) at least one block copolymer as component E comprising at least one hydrophobic block (V) composed essentially of polyisobutene units and also at least one hydrophilic block (W) composed essentially of oxalkylene units and having an average molar mass Mₙ of at least 1000 g/mol.

36. The colored polymeric composition according to claim 35, wherein the average molar mass M, of the hydrophobic blocks (V) of the block copolymer E is in the range from 200 to 10 000 g/mol and the average molar mass Mₙ of the hydrophilic blocks (W) of the block copolymer E is in the range from 1000 to 20 000 g/mol.

37. The colored polymeric composition according to claim 35, wherein said hydrophilic block (W) comprises at least 50% by weight of ethylene oxide units.

38. The colored polymeric composition according to claim 35, wherein said block copolymer E comprises at least one triblock copolymer of the general formula V-W-V.

39. The colored polymeric composition according to claim 35 composed of:
i) 0.1% to 15% by weight of at least one dye concentrate according to claim 1,
ii) 75% to 99.89% by weight of at least one polymeric material, and
iii) 0.01% to 10% by weight of at least one block copolymer according to claim 35.

40. A molding, a film, packaging or a fiber composed of a colored polymeric composition according to claim 34.

41. A process for transmission laser welding, which comprises employing a colored polymeric composition according to claim 34.

42. A process for forgeryproof marking of an article, which comprises employing a dye concentrate according to claim 24.

43. A process for migration-resistant coloration of a polymeric material by incorporation of a dye concentrate according to claim 24 in a nonaqueous way, in the presence of a polyisobutene derivative composed of a least one hydrophobic block X and at least one hydrophilic block Y.

44. The process according to claim 43, wherein additionally a block copolymer E, comprising at least one hydrophobic block (V) composed essentially of polyisobutene units and at least one hydrophilic block (W) composed essentially of oxalkylene units and having an average molar mass Mₙ of at least 1000 g/mol, is incorporated in said polymeric material.
